(19) United States
(12) Patent Application Publication
(10) Pub. No.: US 2025/0193721 A1
(43) Pub. Date: Jun. 12, 2025

(54) DELAY STATUS REPORTING FOR DEADLINE-BASED SCHEDULING

(71) Applicant: QUALCOMM Incorporated, San Diego, CA (US)

(72) Inventors: Linhai HE, San Diego, CA (US); Gavin Bernard HORN, La Jolla, CA (US); Ruiming ZHENG, Beijing (CN); Wanshi CHEN, San Diego, CA (US); Yuchul KIM, San Diego, CA (US); Huilin XU, Temecula, CA (US)

(21) Appl. No.: 18/856,014

(22) PCT Filed: Jun. 15, 2023
(86) PCT No.: PCT/CN2023/100394

§ 371 Date: Oct. 10, 2024

(30) Foreign Application Priority Data
Jun. 22, 2022 (WO) PCT/CN2022/100349

(51) Int. Cl. H04W 24/10; H04W 72/21

(52) U.S. Cl. CPC H04W 24/10; H04W 72/21

(57) ABSTRACT

Methods, systems, and devices for wireless communications are described. The network may configure a packet delay budget for wireless communications over a logical channel and delay status reporting for a user equipment (UE) in accordance with a triggering condition for transmitting a delay status report. If the UE identifies that the triggering condition has been satisfied for a logical channel, the UE may transmit a delay status report indicating a residual delay budget for the logical channel. The UE may transmit the delay status report via a physical uplink shared channel resource or via a physical uplink control channel resource.

### CROSS REFERENCES

The present Application is a 371 national stage filing of International PCT Application No. PCT/CN2023/100394 by He et al. entitled “DELAY STATUS REPORTING FOR DEADLINE-BASED SCHEDULING,” filed Jun. 15, 2023; and claims priority Chinese PCT Patent Application No. PCT/CN2022/100349 by He et al., entitled “DELAY STATUS REPORTING FOR DEADLINE-BASED SCHEDULING,” filed Jun. 22, 2022, each of which is assigned to the assignee hereof, and each of which is expressly incorporated by reference in its entirety herein.

### TECHNICAL FIELD

The following relates to wireless communications, including delay status reporting for deadline-based scheduling.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support delay status reporting for deadline-based scheduling. For example, the described techniques provide for network configured delay status reporting for a user equipment (UE) in accordance with a triggering condition for transmitting a delay status report. The network may configure a packet delay budget for wireless communications over a logical channel and may enable delay status reporting for protocol data units (PDUs) associated with the logical channel in accordance with the trigger. If the UE identifies that the triggering condition has been satisfied for a logical channel, the UE may transmit a delay status report indicating a residual delay budget for the logical channel. The UE may transmit the delay status report via a physical uplink shared channel (PUSCH) resource or via a physical uplink control channel (PUCCH) resource. A PUCCH resource may provide for faster reporting as compared to a PUSCH resource, but a PUCCH resource may not include as much data as compared to a PUSCH resource. A PUCCH resource may be configured for more urgent delay status reports (e.g., based on priority levels of the logical channels).

A method for wireless communications at a UE is described. The method may include receiving first control information that identifies a packet delay budget for wireless communications over a logical channel, receiving second control information that enables delay status reporting for PDUs associated with the logical channel in accordance with a trigger, and transmitting a delay status report indicating a residual delay budget associated with a PDU associated with the logical channel based on the trigger being satisfied, where the residual delay budget is a portion of the packet delay budget for the logical channel.

An apparatus for wireless communications at a UE is described. The apparatus may include at least one processor, memory coupled with (e.g., operatively, communicatively, functionally, electronically, or electrically) the at least one processor, and instructions stored in the memory. The instructions may be executable by the at least one processor (e.g., directly, indirectly, after pre-processing, without pre-processing) to cause the UE to receive first control information that identifies a packet delay budget for wireless communications over a logical channel, receive second control information that enables delay status reporting for PDUs associated with the logical channel in accordance with a trigger, and transmit a delay status report indicating a residual delay budget associated with a PDU associated with the logical channel based on the trigger being satisfied, where the residual delay budget is a portion of the packet delay budget for the logical channel.

Another apparatus for wireless communications at a UE is described. The apparatus may include means for receiving first control information that identifies a packet delay budget for wireless communications over a logical channel, means for receiving second control information that enables delay status reporting for PDUs associated with the logical channel in accordance with a trigger, and means for transmitting a delay status report indicating a residual delay budget associated with a PDU associated with the logical channel based on the trigger being satisfied, where the residual delay budget is a portion of the packet delay budget for the logical channel.

A non-transitory computer-readable medium storing code for wireless communications at a UE is described. The code may include instructions executable by at least one (e.g., directly, indirectly, after pre-processing, without pre-processing) processor to receive first control information that identifies a packet delay budget for wireless communications over a logical channel, receive second control information that enables delay status reporting for PDUs associated with the logical channel in accordance with a trigger, and transmit a delay status report indicating a residual delay budget associated with a PDU associated with the logical channel based on the trigger being satisfied, where the residual delay budget is a portion of the packet delay budget for the logical channel.

Some examples of the method, apparatuses, and non-transitory computer-readable medium described herein may further include operations, features, means, or instructions for receiving, with the second control information, a residual delay budget threshold for the logical channel, where the trigger may be satisfied based on the residual delay budget satisfying the residual delay budget threshold.

In some examples of the method, apparatuses, and non-transitory computer-readable medium described herein, the residual delay budget indicated in the delay status report may be of a medium access control sub-PDU, a radio link control sub- PDU, or a packet data convergence protocol sub-PDU associated with the logical channel.

In some examples of the method, apparatuses, and non-transitory computer-readable medium described herein, the residual delay budget indicated in the delay status report may be a smallest residual delay budget of a set of multiple buffered PDUs in the logical channel and the logical channel may have a highest priority among a set of multiple logical channels for which delay status reporting may be enabled and which may have non-empty buffers.

In some examples of the method, apparatuses, and non-transitory computer-readable medium described herein, transmitting the delay status report may include operations, features, means, or instructions for transmitting the delay status report periodically, where the trigger may be satisfied based on a periodicity parameter of the delay status report.

In some examples of the method, apparatuses, and non-transitory computer-readable medium described herein, transmitting the delay status report may include operations, features, means, or instructions for transmitting the delay status report in portions of a PUSCH allocated for padding of a PUSCH payload.

In some examples of the method, apparatuses, and non-transitory computer-readable medium described herein, transmitting the delay status report may include operations, features, means, or instructions for transmitting the delay status report in connection with a buffer status report being triggered for the logical channel, where the trigger may be satisfied based on the buffer status report being triggered.

In some examples of the method, apparatuses, and non-transitory computer-readable medium described herein, transmitting the delay status report may include operations, features, means, or instructions for transmitting the delay status report via an available PUSCH resource in a medium access control (MAC) control element.

Some examples of the method, apparatuses, and non-transitory computer-readable medium described herein may further include operations, features, means, or instructions for receiving an indication of a PUCCH resource for the delay status reporting for the logical channel.

In some examples of the method, apparatuses, and non-transitory computer-readable medium described herein, transmitting the delay status report may include operations, features, means, or instructions for transmitting the delay status report via a codepoint value included in the PUCCH resource, where the codepoint value may be indicative of the residual delay budget.

In some examples of the method, apparatuses, and non-transitory computer-readable medium described herein, the trigger may be associated with transmitting the delay status report via the PUCCH resource.

In some examples of the method, apparatuses, and non-transitory computer-readable medium described herein, transmitting the delay status report may include operations, features, means, or instructions for transmitting the delay status report via the PUCCH resource over a number of transmission instances in accordance with one of the first control information or the second control information.

In some examples of the method, apparatuses, and non-transitory computer-readable medium described herein, the packet delay budget comprises at least one of a packet delay budget of a quality of service (QoS) flow associated with the logical channel or a PDU set delay budget of a QoS flow associated with the logical channel.

### BRIEF DESCRIPTION OF THE DRAWINGS

FIG. 1 illustrates an example of a wireless communications system that supports delay status reporting for deadline-based scheduling in accordance with one or more aspects of the present disclosure.

FIG. 2 illustrates an example of a wireless communications system that supports delay status reporting for deadline-based scheduling in accordance with one or more aspects of the present disclosure.

FIG. 3 illustrates an example of a process flow that supports delay status reporting for deadline-based scheduling in accordance with one or more aspects of the present disclosure.

FIGS. 4 and 5 show block diagrams of devices that support delay status reporting for deadline-based scheduling in accordance with one or more aspects of the present disclosure.

FIG. 6 shows a block diagram of a communications manager that supports delay status reporting for deadline-based scheduling in accordance with one or more aspects of the present disclosure.

FIG. 7 shows a diagram of a system including a device that supports delay status reporting for deadline-based scheduling in accordance with one or more aspects of the present disclosure.

FIGS. 8 through 10 show flowcharts illustrating methods that support delay status reporting for deadline-based scheduling in accordance with one or more aspects of the present disclosure.

### DETAILED DESCRIPTION

In some wireless communications systems, some applications may demand high reliability and low latency transmissions. For example, extended reality (XR) traffic, may demand high reliability and low latency transmissions. For example, a network entity may transmit video frames to an XR user (e.g., a user equipment (UE)) or a UE may transmit video frames to a network entity. A defined (e.g., minimum) amount of data an application software may process at a time (e.g., the granularity of data processed by an application software) may be referred to as an application data unit (ADU). Because of the strict latency demands associated with ADUs, some packets may become obsolete to an application if the packets are not received within a packet delay budget (e.g., are not received within a duration to be processed with the other packets of the same ADU). Some uplink traffic (e.g., small sized, constant data flows such as pose) may be transmitted using configured grants, but dynamic grants may be used for busty, high data-rate flows such as video in order to efficiently use radio resources.

An end-to-end packet delay budget may be defined between a UE and an application server. The end-to-end packet delay budget may provide a packet delay budget guideline, but may be impractical to apply for a UE for layer 2 procedures for uplink transmissions. For layer 2 procedures, for downlink transmissions, the UE may be unaware of the routing delay through the core network and the scheduling delay at the serving base station for each individual packet. For layer 2 procedures, for uplink transmissions, the network (e.g., a serving network entity) may be unaware of the delay of each packet before the packet is transmitted on a physical uplink shared channel (PUSCH) or a physical uplink control channel (PUCCH). A residual delay budget refers to a remaining delay budget for a protocol data unit (PDU) before the PDU becomes obsolete (e.g., is discarded). Currently, there is no signaling for a UE to indicate the residual delay budget for a given PDU. Accordingly, the network may transmit uplink grants for transmissions of PDUs or retransmissions of PDUs (e.g., based on hybrid automatic repeat request (HARQ) feedback) even when the transmission of the PDU or retransmission of the PDU would be obsolete (e.g., because the transmission or retransmission would be outside of the packet delay budget associated with the ADU for the PDU).

The network may configure delay status reporting for a UE in accordance with a triggering condition for transmitting a delay status report. For example, the network may configure a packet delay budget for wireless communications over a logical channel and may enable delay status reporting for protocol data units associated with the logical channel in accordance with the trigger. If the UE identifies that the triggering condition has been satisfied for a PDU associated with a logical channel, the UE may transmit a delay status report indicating a residual delay budget for the PDU associated with the logical channel.

In some cases, each buffered PDU in a logical channel may have a respective residual delay budget, and the UE may transmit the delay status report based on the smallest residual delay budget among the buffered PDUs for the logical channel satisfying the triggering condition. In some cases, the UE may report the residual delay budgets for each of the buffered PDUs in the logical channel. In some cases, the UE may report residual delay budgets for PDUs associated with multiple logical channels based on the triggering condition being satisfied in a PDU associated with the highest priority logical channel among the multiple logical channels. In some cases, the UE may be configured to periodically transmit a delay status report to the network. In some cases, the UE may be configured to transmit a delay status report for a logical channel whenever the UE is triggered to transmit a buffer status report for the logical channel. The UE may transmit the delay status report via a PUSCH resource (e.g., of a medium access control (MAC) control element (MAC-CE) or via portions of a PUSCH resource for padding a PUSCH payload) or via a PUCCH resource. A PUCCH resource may provide for faster reporting as compared to a PUSCH resource, but a PUCCH resource may not include as much data as compared to a PUSCH resource. Accordingly, a PUCCH resource may be configured for more urgent delay status reports (e.g., based on priority levels of the logical channels).

Aspects of the disclosure are initially described in the context of wireless communications systems. Aspects of the disclosure are further illustrated by and described with reference to process flows, apparatus diagrams, system diagrams, and flowcharts that relate to delay status reporting for deadline-based scheduling.

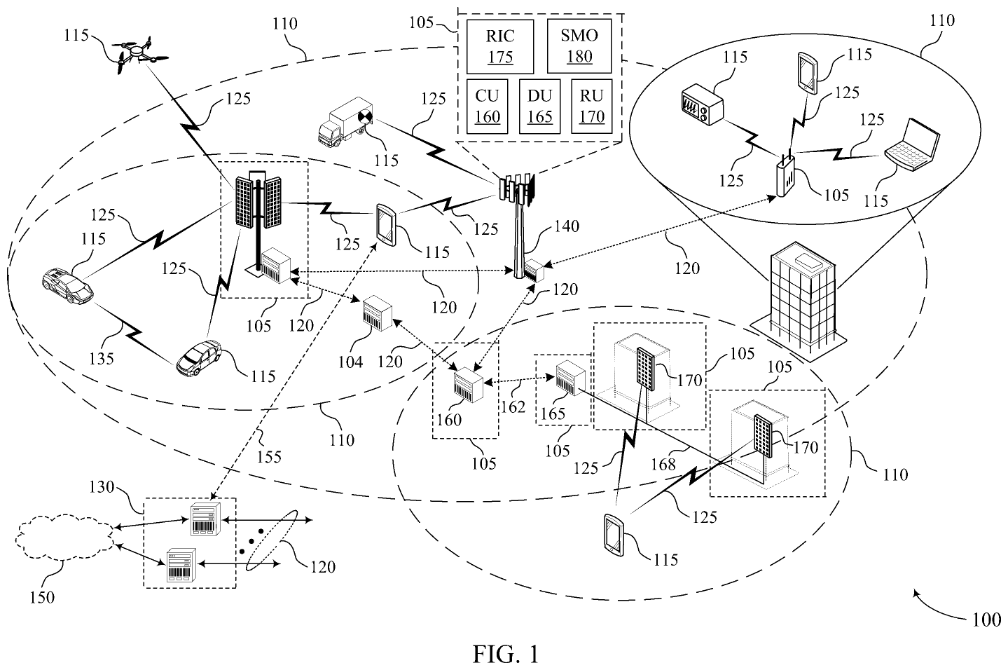

FIG. 1 illustrates an example of a wireless communications system 100 that supports delay status reporting for deadline-based scheduling in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support delay status reporting for deadline-based scheduling as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), etc., and NB-IoT may include eNB-IoT (enhanced NB-IoT), and FeNB-IoT (further enhanced NB-IoT).

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

In some examples, some applications supported by the wireless communications system 100 may demand high reliability and low latency transmissions. For example, the wireless communications system 100 may support XR traffic, which may demand high reliability and low latency transmissions. For example, a network entity 105 may transmit video frames to an XR user (e.g., a UE 115) or a UE 115 may transmit video frames to a network entity 105. A delay budget (e.g., a packet delay budget) may be defined as an end-to-end packet delay budget between the UE 115 and an application server (e.g., the network entity 105). The network entity 105 may establish one or more PDU sessions for the UE 115, and each PDU session may be associated with one or more quality of service (QoS) flows. QoS may be defined as a measurement of performance that the UE 115 or the network entity 115 is capable of achieving for associated traffic (e.g., a flow, such as a QoS flow). Thus, different QoS flows in a PDU session may be associated with data packets, logical channels, or the like, that each have different QoS parameters or requirements (e.g., bit rate, packet loss rate, throughput, or transmission delay, among other examples). That is, traffic with the same or similar QoS requirements may be assigned to a same QoS flow. For instance, in XR applications, a QoS flow may correspond to a logical channel carrying data packets (e.g., ADUs) having relatively high reliability and relatively low latency requirements. Each QoS flow may be associated with a unique QoS flow identifier (QFI).

A PDU set may be defined as a group of data packets (e.g., PDUs) from an application (e.g., an XR application) that carry a payload of one or more ADUs, where the one or more ADUs are processed together by the application. In some examples, QoS may be handled on a per-PDU set basis. That is, QoS parameters may be PDU set-specific. For example, each PDU set may be associated with a respective QoS flow of a logical channel, and each QoS flow may be associated with a respective PDU set delay budget, PDU set error rate, PDU set integrated handling information, or a combination thereof. In such examples, a packet delay budget for a PDU set (e.g., a PDU set delay budget) may be defined as an upper limit for the delay that a PDU set may experience (e.g., a time duration between reception of a first PDU of the PDU set at its destination and the time when all PDUs of a PDU set have been successfully received at the destination).

Alternatively, when QoS is not handled on a per-PDU set basis, a delay budget (e.g., a packet delay budget) may be defined as a packet delay budget of a QoS flow associated with a logical channel. Here, the packet delay budget may be an upper limit for a time that a packet may be delayed between the UE 115 and a UPF.

To support high reliability and low latency transmissions in the wireless communication system 100, the network (e.g., a serving network entity 105) may configure delay status reporting for a UE 115 in accordance with a triggering condition for transmitting a delay status report. For example, the network may configure a packet delay budget (e.g., a PDU set delay budget, a packet delay budget) for wireless communications over a logical channel and may enable delay status reporting for PDUs associated with the logical channel in accordance with the trigger. If the UE 115 identifies that the triggering condition has been satisfied for a PDU associated with a logical channel, the UE 115 may transmit a delay status report indicating a residual delay budget for the PDU associated with the logical channel.

In some cases, each buffered PDU in a logical channel may have a respective residual delay budget, and the UE may transmit the delay status report based on the smallest residual delay budget among the buffered PDUs for the logical channel satisfying the triggering condition. In some cases, the UE 115 may report the residual delay budgets for each of the buffered PDUs in the logical channel. In some cases, the UE may report residual delay budgets for PDUs associated with multiple logical channels based on the triggering condition being satisfied in a PDU associated with the highest priority logical channel among the multiple logical channels. In some cases, the UE 115 may be configured to periodically transmit a delay status report to the network. In some cases, the UE 115 may be configured to transmit a delay status report for a logical channel whenever the UE is triggered to transmit a buffer status report for the logical channel. The UE 115 may transmit the delay status report via a PUSCH resource (e.g., of a MAC-CE or via portions of a PUSCH resource for padding a PUSCH payload) or via a PUCCH resource. A PUCCH resource may provide for faster reporting as compared to a PUSCH resource, but a PUCCH resource may not include as much data as compared to a PUSCH resource. Accordingly, a PUCCH resource may be configured for more urgent delay status reports (e.g., based on priority levels of the logical channels).

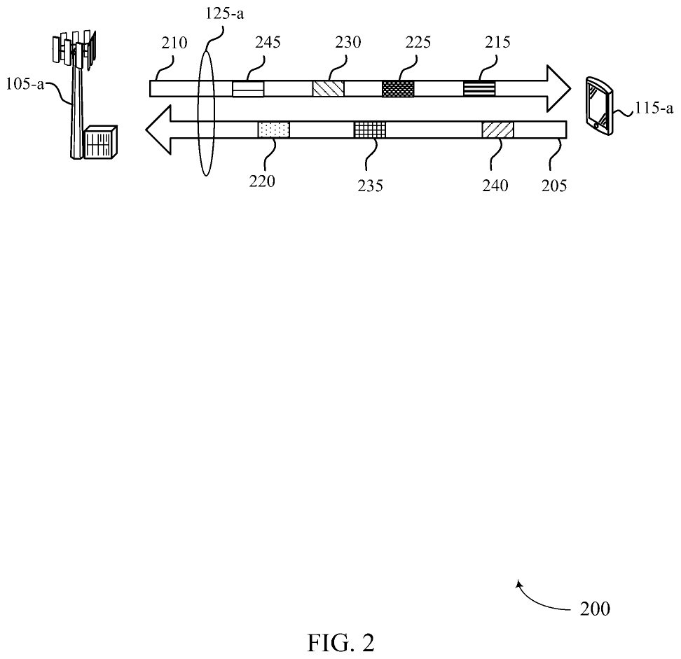

FIG. 2 illustrates an example of a wireless communications system 200 that supports delay status reporting for deadline-based scheduling in accordance with one or more aspects of the present disclosure. In some examples, the wireless communications system 200 may implement aspects of wireless communications system 100. The wireless communications system 200 may include a UE 115-a, which may be an example of a UE 115 as described herein. The wireless communications system 200 may include a network entity 105-a, which may be an example of a network entity 105 as described herein.

The UE 115-a may communicate with the network entity 105-a using a communication link 125-a, which may be examples of NR or LTE links between the UE 115-a and the network entity 105-a. The communication link 125-a may include a bi-directional link that enables both uplink and downlink communication. For example, the UE 115-a may transmit uplink signals 205, such as uplink control signals or uplink data signals, to the network entity 105-a using the communication link 125-a and the network entity 105-a may transmit downlink signals 210, such as downlink control signals or downlink data signals, to the UE 115-a using the communication link 125-a.

The network entity 105-a may transmit one or more uplink grants 215 to the UE 115-a scheduling one or more uplink transmissions 220 over one or more logical channels. In some cases, the one or more uplink transmissions 220 may be associated with one or more packet delay budgets. For example, the network entity 105-a may transmit first control information 225 that identifies a packet delay budget for wireless communications over a logical channel. The packet delay budget may be based on a QoS flow associated with the logical channel. When the QoS flow is based on PDU set QoS handling, the packet delay budget may include or be an example of a PDU set delay budget of the QoS flow associated with the logical channel. Alternatively, when the QoS flow is not PDU set-based, the packet delay budget may include or be an example of a packet delay budget of the QoS flow associated with the logical channel. In some cases, the first control information 225 may identify respective packet delay budgets for wireless communications over a set of respective logical channels (e.g., based on a corresponding set of QoS flows for the set of respective logical channels).

The network entity 105-a may be unaware of the residual packet delay budget for the logical channel, where the residual delay budget is a portion of the packet delay budget (e.g., the PDU set delay budget, the packet delay budget) for the logical channel. Accordingly, the network entity 105-a may transmit second control information 230 that enables delay status reporting for PDUs associated with the logical channel in accordance with a trigger. The UE 115-a may transmit a delay status report 235 indicating a residual delay budget associated with the logical channel based on the trigger being satisfied. Once triggered, a delay status report 235 may remain pending until transmitted by the UE 115-a.

In some examples, the UE 115-a may trigger a delay status report 235 if the residual delay budget of a MAC sub-PDU, a radio link control (RLC) sub-PDU, or a packet data convergence protocol (PDCP) sub-PDU for a logical channel configured with residual delay budget reporting has exceeded a configured threshold (e.g., where the configured threshold is indicated in the second control information 230) when the MAC sub-PDU, RLC sub-PDU, or PDCP sub-PDU is transmitted in a PUSCH resource. In some cases, the delay status report 235 may be transmitted in a MAC-CE when there is a PUSCH resource available. In some cases, the delay status report 235 triggered by the residual delay budget of a MAC sub-PDU, RLC sub-PDU, or PDCP sub-PDU for a logical channel configured with residual delay budget reporting exceeding a configured threshold may include only the residual delay budget for that MAC sub-PDU, RLC sub-PDU, or PDCP sub-PDU.

In some examples, a logical channel m may have a highest priority among all logical channels configured with delay status reporting. For example, the second control information may enable delay status reporting for multiple logical channels including logical channel m. If logical channel m has non-empty buffers and Zm, the smallest residual delay budget among the buffered protocol data units in the logical channel m, has exceeded a configured threshold (e.g., where the configured threshold is indicated in the second control information 230), the UE 115-a may trigger a delay status report 235.

In some examples, the network entity 105-a may configure the UE 115-a to transmit a delay status report 235 periodically (e.g., the second control information 230 may indicate a periodicity parameter). In some example, the network entity 105-a may configure the UE 115-a to transmit a delay status report 235 as part of padding (e.g., in portions of a PUSCH allocated for padding a PUSCH payload). In some examples, the network entity 105-a may configure the UE 115-a to transmit a delay status report 235 when a regular buffer status report is triggered.

In some cases, a delay status report 235 may be transmitted in a MAC-CE when there is a PUSCH resource available. The delay status report 235 may include Zm, the smallest residual delay budget among the buffered protocol data units in each logical channel configured with delay status reporting. The PUSCH resource for transmitting the delay status report 235 may be a dynamic grant or a configured grant. In some cases, if no PUSCH resource is available for transmitting a delay status report 235, the UE 115-a may trigger a scheduling request 240 to prompt the network to transmit a grant 245 for a PUSCH to transmit a delay status report 235.

In some cases, the network entity 105-a may configure (e.g., in the second control information 230) PUCCH resources for the UE 115-a to report urgent delay status of a delay status reporting enabled logical channel. PUCCH resource may be faster than PUSCH resources, but PUCCH resources may provide less information (e.g., several bits of information) as compared to PUSCH. Accordingly, a PUCCH resource may be configured for more urgent delay status reports (e.g., based on priority levels of the logical channels).

The network entity 105-a may configure which logical channels may use PUCCH resources for reporting delay status reports 235. For each logical channel configured to use PUCCH resources for reporting delay status reports 235, the network entity 105-a may configure (e.g., indicate in the second control information 230), the codepoint mapping for the delay status reporting for the logical channels. For example, if a PUCCH resource for delay status reporting supports a 3-bit payload, the codepoint mapping may describe how possible values of the residual delay budget are mapped to a value in the PUCCH payload.

The network entity 105-a may configure which triggers are associated with PUCCH resources versus PUSCH resources. For example, a logical channel m having a highest priority among all logical channels configured with delay status reporting may be associated with transmitting delays tatus reports via PUCCH resources. Once a delay status report 235 associated with PUCCH resources is triggered, the delay status report 235 may be transmitted using the configured PUCCH resource. The network entity 105-a may indicate (e.g., in the first control information 225 or the second control information 230), a number of transmission instances over which to transmit the delay status report over the PUCCH resource.

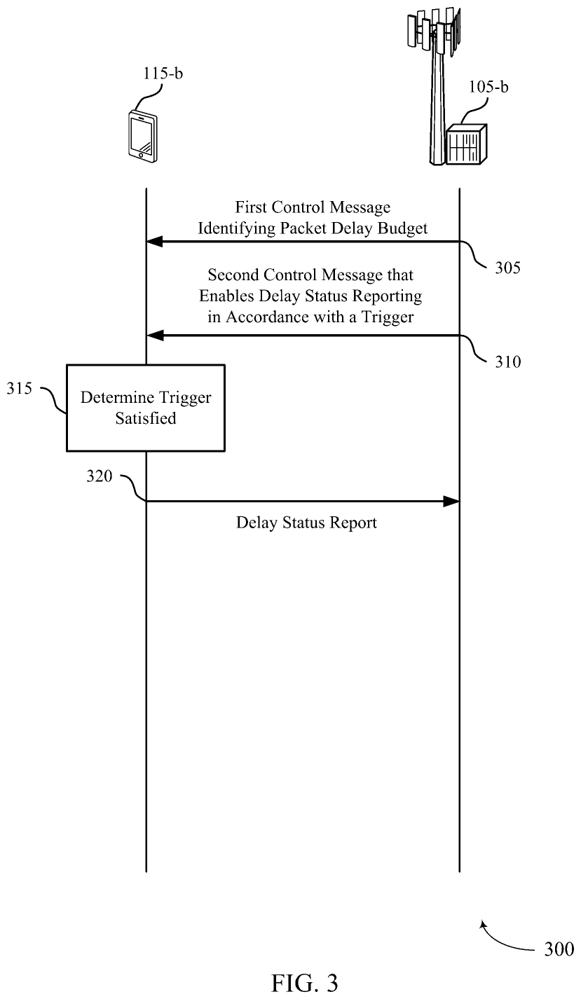

FIG. 3 illustrates an example of a process flow 300 that supports delay status reporting for deadline-based scheduling in accordance with one or more aspects of the present disclosure. The process flow 300 may include a UE 115-b, which may be an example of a UE 115 as described herein. The process flow 300 may include a network entity 105-b, which may be an example of a network entity 105 as described herein. In the following description of the process flow 300, the operations between the network entity 105-b and the UE 115-b may be transmitted in a different order than the example order shown, or the operations performed by the network entity 105-b and the UE 115-b may be performed in different orders or at different times. Some operations may also be omitted from the process flow 300, and other operations may be added to the process flow 300.

At 305, the UE 115-b may receive, from the network entity 105-b, first control information that identifies a packet delay budget for wireless communications over a logical channel. In some examples, the packet delay budget may be a packet delay budget of a QoS flow associated with the logical channel. In other examples, the packet delay budget may be a PDU set delay budget of the QoS flow of the logical channel.

At 310, the UE 115-b may receive, from the network entity 105-b, second control information that enables delay status reporting for PDUs associated with the logical channel in accordance with a trigger.

At 315, the UE 115-b may determine that the trigger has been satisfied.

At 320, the UE 115-b may transmit, to the network entity 105-b, a delay status report indicating a residual delay budget associated with the logical channel based on the trigger being satisfied, where the residual delay budget is a portion of the packet delay budget for the logical channel.

In some cases, the UE 115-b may receive, with the second control information, a residual delay budget threshold for the logical channel, where the trigger is satisfied at 315 based on the residual delay budget satisfying the residual delay budget threshold. In some cases, the residual delay budget indicated in the delay status report is of a MAC sub-PDU, an RLC sub-PDU, or a PDCP sub-PDU associated with the logical channel. In some cases, the residual delay budget indicated in the delay status report may be a smallest residual delay budget of a plurality of buffered PDUs in the logical channel, where the logical channel has a highest priority among a plurality of logical channels for which delay status reporting is enabled and which have non-empty buffers.

In some cases, the UE 115-b may transmit the delay status report periodically, and the trigger is satisfied at 315 based on periodicity parameter of the delay status report. In some cases, the periodicity parameter may be indicated in the second control information received at 310.

In some cases, the UE 115-b may transmit the delay status report in portions of a PUSCH allocated for padding of a PUSCH payload.

In some cases, the UE 115-b may transmit the delay status report in connection with a buffer status report being triggered for the logical channel, where the trigger is satisfied at 315 based on the buffer status report being triggered.

In some cases, the UE 115-b may transmit the delay status report via an available PUSCH resource in a MAC-CE.

In some cases, the UE 115-b may receive an indication of a PUCCH resource for the delay status reporting for the logical channel. In some cases, the UE 115-b may transmit the delay status report via a codepoint value included in the PUCCH resource, where the codepoint value is indicative of the residual delay budget. In some cases, the trigger may be associated with transmitting the delay status report via the PUCCH resource. In some cases, the UE 115-b may transmit the delay status report via the PUCCH resource over a number of transmission instances in accordance with one of the first control information or the second control information.

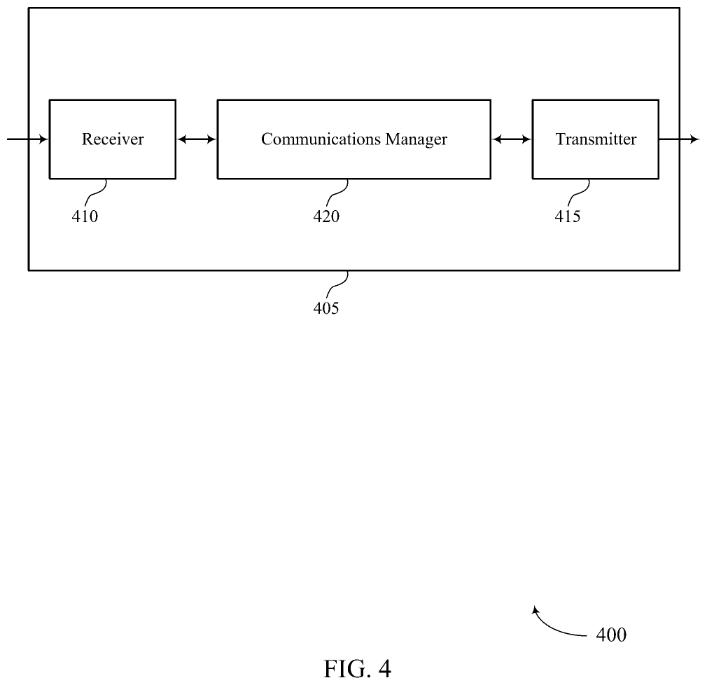

FIG. 4 shows a block diagram 400 of a device 405 that supports delay status reporting for deadline-based scheduling in accordance with one or more aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to delay status reporting for deadline-based scheduling). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to delay status reporting for deadline-based scheduling). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of delay status reporting for deadline-based scheduling as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 420, the receiver 410, the transmitter 415, or various combinations or components thereof may be implemented in code (e.g., as communications management software) executed by a processor. If implemented in code executed by a processor, the functions of the communications manager 420, the receiver 410, the transmitter 415, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications at a UE in accordance with examples as disclosed herein. For example, the communications manager 420 may be configured as or otherwise support a means for receiving first control information that identifies a packet delay budget for wireless communications over a logical channel. The communications manager 420 may be configured as or otherwise support a means for receiving second control information that enables delay status reporting for PDUs associated with the logical channel in accordance with a trigger. The communications manager 420 may be configured as or otherwise support a means for transmitting a delay status report indicating a residual delay budget associated with the logical channel based on the trigger being satisfied, where the residual delay budget is a portion of the packet delay budget for the logical channel.

By including or configuring the communications manager 420 in accordance with examples as described herein, the device 405 (e.g., a processor controlling or otherwise coupled with the receiver 410, the transmitter 415, the communications manager 420, or a combination thereof) may support techniques for more efficient utilization of communication resources by enabling delay status reporting.

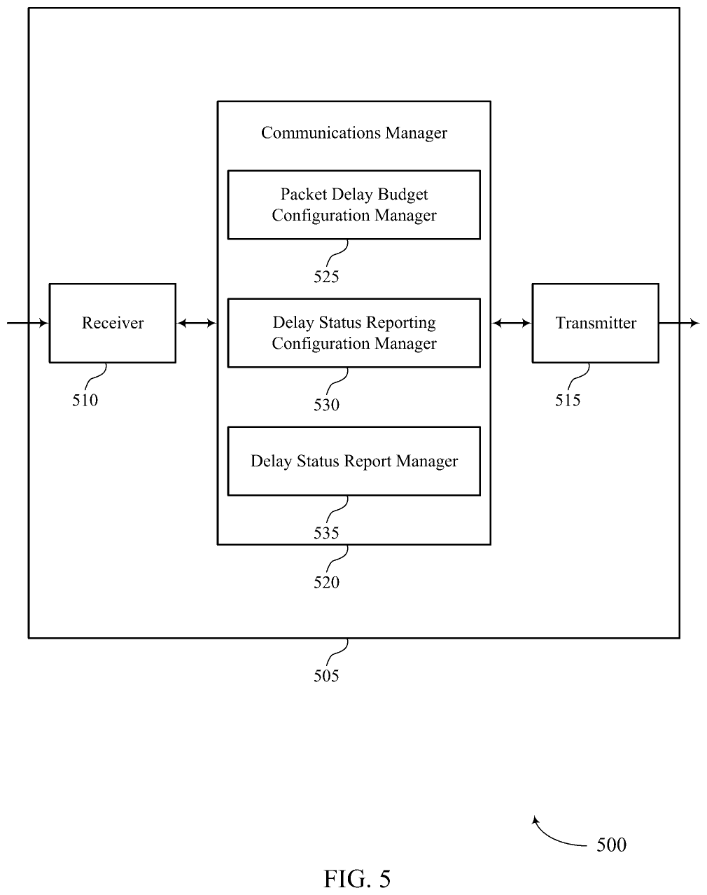

FIG. 5 shows a block diagram 500 of a device 505 that supports delay status reporting for deadline-based scheduling in accordance with one or more aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to delay status reporting for deadline-based scheduling). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to delay status reporting for deadline-based scheduling). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of delay status reporting for deadline-based scheduling as described herein. For example, the communications manager 520 may include a packet delay budget configuration manager 525, a delay status reporting configuration manager 530, a delay status report manager 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. The packet delay budget configuration manager 525 may be configured as or otherwise support a means for receiving first control information that identifies a packet delay budget for wireless communications over a logical channel. The delay status reporting configuration manager 530 may be configured as or otherwise support a means for receiving second control information that enables delay status reporting for PDUs associated with the logical channel in accordance with a trigger. The delay status report manager 535 may be configured as or otherwise support a means for transmitting a delay status report indicating a residual delay budget associated with the logical channel based on the trigger being satisfied, where the residual delay budget is a portion of the packet delay budget for the logical channel.

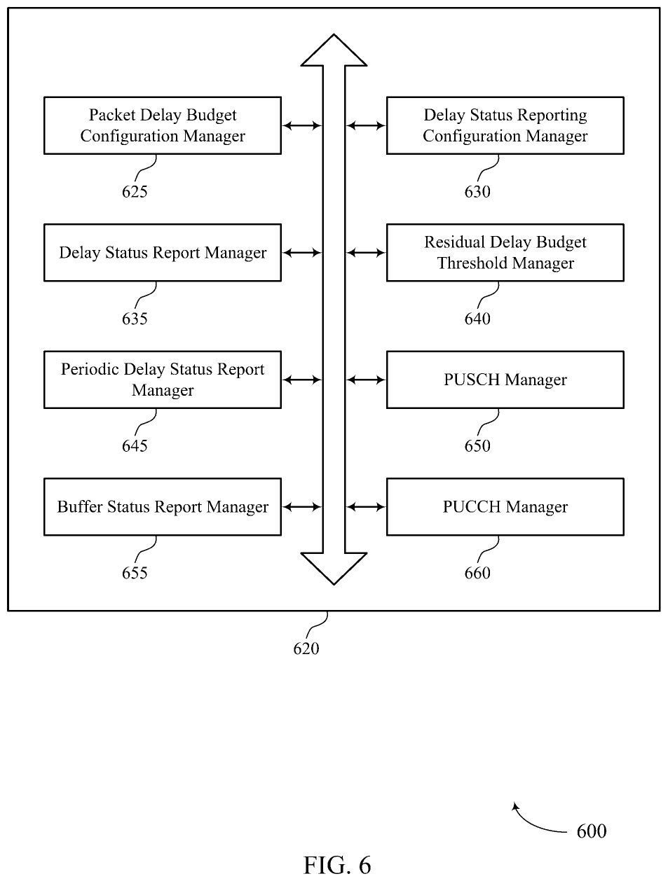

FIG. 6 shows a block diagram 600 of a communications manager 620 that supports delay status reporting for deadline-based scheduling in accordance with one or more aspects of the present disclosure. The communications manager 620 may be an example of aspects of a communications manager 420, a communications manager 520, or both, as described herein. The communications manager 620, or various components thereof, may be an example of means for performing various aspects of delay status reporting for deadline-based scheduling as described herein. For example, the communications manager 620 may include a packet delay budget configuration manager 625, a delay status reporting configuration manager 630, a delay status report manager 635, a residual delay budget threshold manager 640, a periodic delay status report manager 645, an PUSCH manager 650, a buffer status report manager 655, a PUCCH manager 660, or any combination thereof. Each of these components may communicate, directly or indirectly, with one another (e.g., via one or more buses).

The communications manager 620 may support wireless communications at a UE in accordance with examples as disclosed herein. The packet delay budget configuration manager 625 may be configured as or otherwise support a means for receiving first control information that identifies a packet delay budget for wireless communications over a logical channel. The delay status reporting configuration manager 630 may be configured as or otherwise support a means for receiving second control information that enables delay status reporting for PDUs associated with the logical channel in accordance with a trigger. The delay status report manager 635 may be configured as or otherwise support a means for transmitting a delay status report indicating a residual delay budget associated with the logical channel based on the trigger being satisfied, where the residual delay budget is a portion of the packet delay budget for the logical channel.

In some examples, the residual delay budget threshold manager 640 may be configured as or otherwise support a means for receiving, with the second control information, a residual delay budget threshold for the logical channel, where the trigger is satisfied based on the residual delay budget satisfying the residual delay budget threshold.

In some examples, the residual delay budget indicated in the delay status report is of a MAC sub-PDU, an RLC sub-PDU, or a PDCP sub-PDU associated with the logical channel.

In some examples, the residual delay budget indicated in the delay status report is a smallest residual delay budget of a set of multiple buffered protocol data units in the logical channel. In some examples, the logical channel has a highest priority among a set of multiple logical channels for which delay status reporting is enabled and which have non-empty buffers.

In some examples, to support transmitting the delay status report, the periodic delay status report manager 645 may be configured as or otherwise support a means for transmitting the delay status report periodically, where the trigger is satisfied based on a periodicity parameter of the delay status report.

In some examples, to support transmitting the delay status report, the PUSCH manager 650 may be configured as or otherwise support a means for transmitting the delay status report in portions of a PUSCH allocated for padding of a PUSCH payload.

In some examples, to support transmitting the delay status report, the buffer status report manager 655 may be configured as or otherwise support a means for transmitting the delay status report in connection with a buffer status report being triggered for the logical channel, where the trigger is satisfied based on the buffer status report being triggered.

In some examples, to support transmitting the delay status report, the PUSCH manager 650 may be configured as or otherwise support a means for transmitting the delay status report via an available PUSCH resource in a MAC-CE.

In some examples, the PUCCH manager 660 may be configured as or otherwise support a means for receiving an indication of a PUCCH resource for the delay status reporting for the logical channel.

In some examples, to support transmitting the delay status report, the PUCCH manager 660 may be configured as or otherwise support a means for transmitting the delay status report via a codepoint value included in the PUCCH resource, where the codepoint value is indicative of the residual delay budget.

In some examples, the trigger is associated with transmitting the delay status report via the PUCCH resource.

In some examples, to support transmitting the delay status report, the PUCCH manager 660 may be configured as or otherwise support a means for transmitting the delay status report via the PUCCH resource over a number of transmission instances in accordance with one of the first control information or the second control information.

In some examples, the packet delay budget comprises at least one of a packet delay budget of a QoS flow associated with the logical channel and a PDU set delay budget of a QoS flow associated with the logical channel.

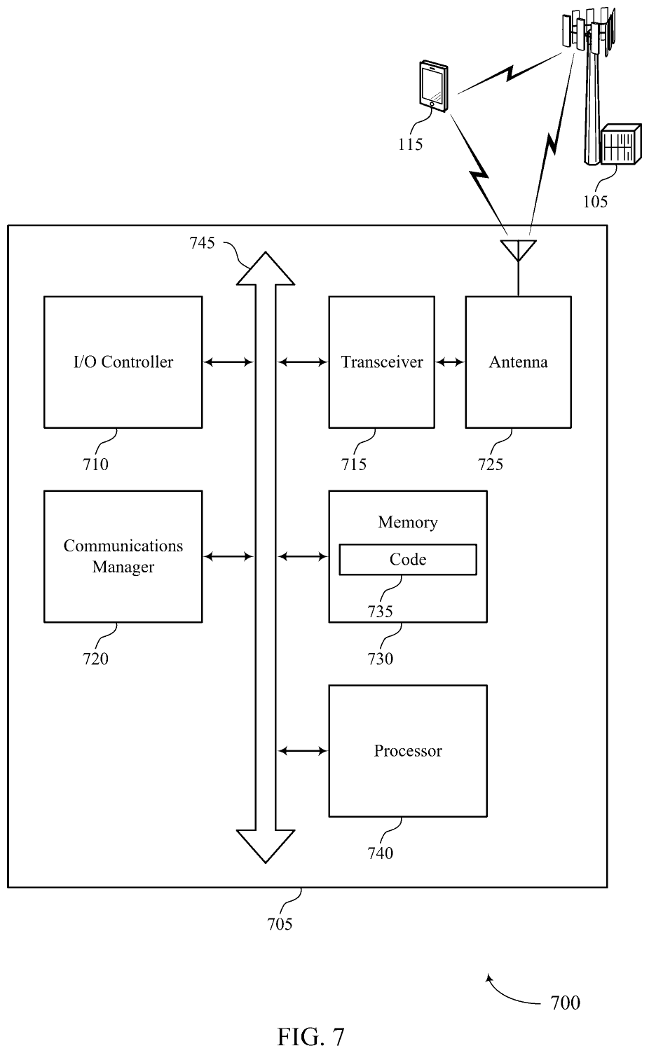

FIG. 7 shows a diagram of a system 700 including a device 705 that supports delay status reporting for deadline-based scheduling in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, or electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting delay status reporting for deadline-based scheduling). For example, the device 705 or a component of the device 705 may include a processor 740 and memory 730 coupled with or to the processor 740, the processor 740 and memory 730 configured to perform various functions described herein.

The communications manager 720 may support wireless communications at a UE in accordance with examples as disclosed herein. For example, the communications manager 720 may be configured as or otherwise support a means for receiving first control information that identifies a packet delay budget for wireless communications over a logical channel. The communications manager 720 may be configured as or otherwise support a means for receiving second control information that enables delay status reporting for PDUs associated with the logical channel in accordance with a trigger. The communications manager 720 may be configured as or otherwise support a means for transmitting a delay status report indicating a residual delay budget associated with the logical channel based on the trigger being satisfied, where the residual delay budget is a portion of the packet delay budget for the logical channel.

By including or configuring the communications manager 720 in accordance with examples as described herein, the device 705 may support techniques for improved communication reliability, more efficient utilization of communication resources, improved coordination between devices, and improved utilization of processing capability by enabling delay status reporting.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of delay status reporting for deadline-based scheduling as described herein, or the processor 740 and the memory 730 may be otherwise configured to perform or support such operations.

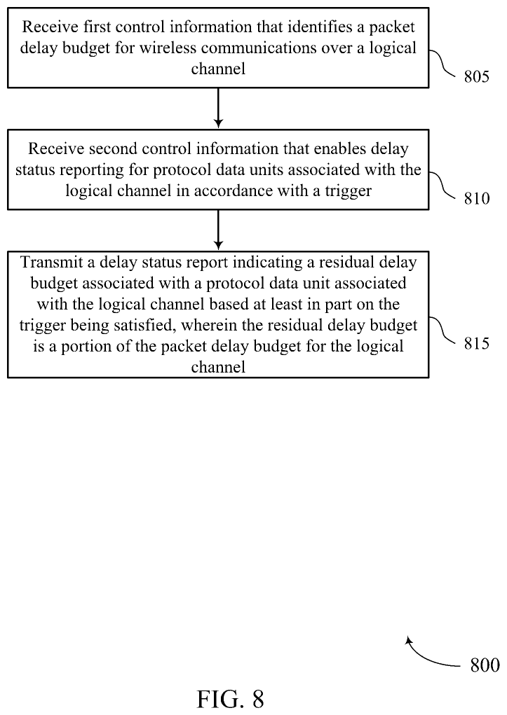

FIG. 8 shows a flowchart illustrating a method 800 that supports delay status reporting for deadline-based scheduling in accordance with one or more aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include receiving first control information that identifies a packet delay budget for wireless communications over a logical channel. The operations of 805 may be performed in accordance with examples as disclosed herein. In some examples, aspects of the operations of 805 may be performed by a packet delay budget configuration manager 625 as described with reference to FIG. 6.

At 810, the method may include receiving second control information that enables delay status reporting for PDUs associated with the logical channel in accordance with a trigger. The operations of 810 may be performed in accordance with examples as disclosed herein. In some examples, aspects of the operations of 810 may be performed by a delay status reporting configuration manager 630 as described with reference to FIG. 6.

At 815, the method may include transmitting a delay status report indicating a residual delay budget associated with the logical channel based at least in part on the trigger being satisfied, where the residual delay budget is a portion of the packet delay budget for the logical channel. The operations of 815 may be performed in accordance with examples as disclosed herein. In some examples, aspects of the operations of 815 may be performed by a delay status report manager 635 as described with reference to FIG. 6.

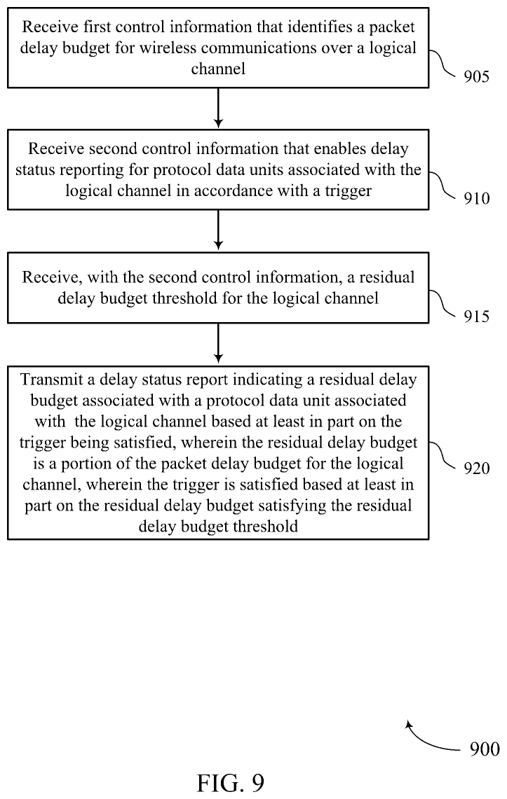

FIG. 9 shows a flowchart illustrating a method 900 that supports delay status reporting for deadline-based scheduling in accordance with one or more aspects of the present disclosure. The operations of the method 900 may be implemented by a UE or its components as described herein. For example, the operations of the method 900 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 905, the method may include receiving first control information that identifies a packet delay budget for wireless communications over a logical channel. The operations of 905 may be performed in accordance with examples as disclosed herein. In some examples, aspects of the operations of 905 may be performed by a packet delay budget configuration manager 625 as described with reference to FIG. 6.

At 910, the method may include receiving second control information that enables delay status reporting for PDUs associated with the logical channel in accordance with a trigger. The operations of 910 may be performed in accordance with examples as disclosed herein. In some examples, aspects of the operations of 910 may be performed by a delay status reporting configuration manager 630 as described with reference to FIG. 6.

At 915, the method may include receiving, with the second control information, a residual delay budget threshold for the logical channel. The operations of 915 may be performed in accordance with examples as disclosed herein. In some examples, aspects of the operations of 915 may be performed by a residual delay budget threshold manager 640 as described with reference to FIG. 6.

At 920, the method may include transmitting a delay status report indicating a residual delay budget associated with the logical channel based at least in part on the trigger being satisfied, where the residual delay budget is a portion of the packet delay budget for the logical channel, where the trigger is satisfied based at least in part on the residual delay budget satisfying the residual delay budget threshold. The operations of 920 may be performed in accordance with examples as disclosed herein. In some examples, aspects of the operations of 920 may be performed by a delay status report manager 635 as described with reference to FIG. 6.

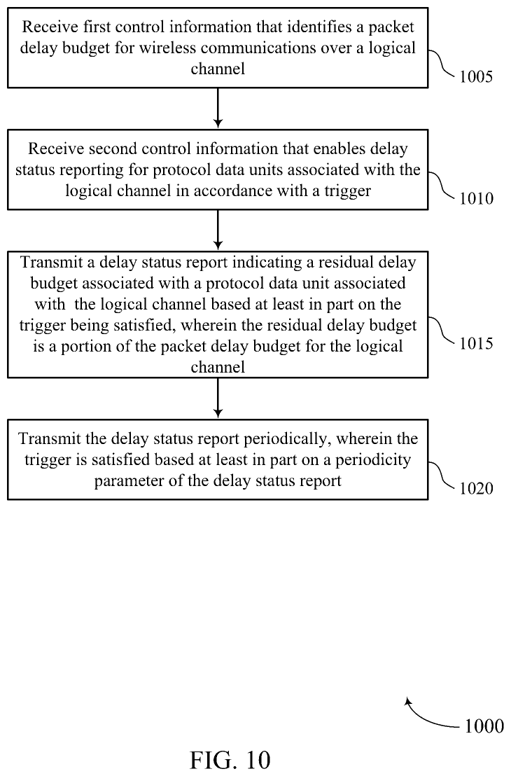

FIG. 10 shows a flowchart illustrating a method 1000 that supports delay status reporting for deadline-based scheduling in accordance with one or more aspects of the present disclosure. The operations of the method 1000 may be implemented by a UE or its components as described herein. For example, the operations of the method 1000 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1005, the method may include receiving first control information that identifies a packet delay budget for wireless communications over a logical channel. The operations of 1005 may be performed in accordance with examples as disclosed herein. In some examples, aspects of the operations of 1005 may be performed by a packet delay budget configuration manager 625 as described with reference to FIG. 6.

At 1010, the method may include receiving second control information that enables delay status reporting for PDUs associated with the logical channel in accordance with a trigger. The operations of 1010 may be performed in accordance with examples as disclosed herein. In some examples, aspects of the operations of 1010 may be performed by a delay status reporting configuration manager 630 as described with reference to FIG. 6.

At 1015, the method may include transmitting a delay status report indicating a residual delay budget associated with the logical channel based at least in part on the trigger being satisfied, where the residual delay budget is a portion of the packet delay budget for the logical channel. The operations of 1015 may be performed in accordance with examples as disclosed herein. In some examples, aspects of the operations of 1015 may be performed by a delay status report manager 635 as described with reference to FIG. 6.

At 1020, the method may include transmitting the delay status report periodically, where the trigger is satisfied based at least in part on a periodicity parameter of the delay status report. The operations of 1020 may be performed in accordance with examples as disclosed herein. In some examples, aspects of the operations of 1020 may be performed by a periodic delay status report manager 645 as described with reference to FIG. 6.

The following provides an overview of aspects of the present disclosure:

Aspect 1: A method for wireless communications at a UE, comprising: receiving first control information that identifies a packet delay budget for wireless communications over a logical channel; receiving second control information that enables delay status reporting for PDUs associated with the logical channel in accordance with a trigger; and transmitting a delay status report indicating a residual delay budget associated with a PDU associated with the logical channel based at least in part on the trigger being satisfied, wherein the residual delay budget is a portion of the packet delay budget for the logical channel.

Aspect 2: The method of aspect 1, further comprising: receiving, with the second control information, a residual delay budget threshold for the logical channel, wherein the trigger is satisfied based at least in part on the residual delay budget satisfying the residual delay budget threshold.

Aspect 3: The method of aspect 2, wherein the residual delay budget indicated in the delay status report is of a medium access control sub-PDU, a radio link control sub-PDU, or a packet data convergence protocol sub-PDU associated with the logical channel.

Aspect 4: The method of any of aspects 2 through 3, wherein the residual delay budget indicated in the delay status report is a smallest residual delay budget of a plurality of buffered PDUs in the logical channel, and the logical channel has a highest priority among a plurality of logical channels for which delay status reporting is enabled and which have non-empty buffers.

Aspect 5: The method of any of aspects 1 through 4, wherein transmitting the delay status report comprises: transmitting the delay status report periodically, wherein the trigger is satisfied based at least in part on a periodicity parameter of the delay status report.

Aspect 6: The method of any of aspects 1 through 5, wherein transmitting the delay status report comprises: transmitting the delay status report in portions of a PUSCH allocated for padding of a PUSCH payload.

Aspect 7: The method of any of aspects 1 through 6, wherein transmitting the delay status report comprises: transmitting the delay status report in connection with a buffer status report being triggered for the logical channel, wherein the trigger is satisfied based at least in part on the buffer status report being triggered.

Aspect 8: The method of any of aspects 1 through 7, wherein transmitting the delay status report comprises: transmitting the delay status report via an available PUSCH resource in a MAC-CE.

Aspect 9: The method of any of aspects 1 through 8, further comprising: receiving an indication of a PUCCH resource for the delay status reporting for the logical channel.

Aspect 10: The method of aspect 9, wherein transmitting the delay status report comprises: transmitting the delay status report via a codepoint value included in the PUCCH resource, wherein the codepoint value is indicative of the residual delay budget.

Aspect 11: The method of any of aspects 9 through 10, wherein the trigger is associated with transmitting the delay status report via the PUCCH resource.

Aspect 12: The method of any of aspects 9 through 11, wherein transmitting the delay status report comprises: transmitting the delay status report via the PUCCH resource over a number of transmission instances in accordance with one of the first control information or the second control information.

Aspect 13: The method of any of aspects 1 through 12, wherein the packet delay budget comprises at least one of a packet delay budget of a QoS flow associated with the logical channel or a PDU set delay budget of a QoS flow associated with the logical channel.

Aspect 14: An apparatus for wireless communications at a UE, comprising at least one processor and memory coupled to the at least one processor, the memory storing instructions executable by the at least one processor to cause the UE to perform a method of any of aspects 1 through 12.

Aspect 15: An apparatus for wireless communications at a UE, comprising at least one means for performing a method of any of aspects 1 through 12.

Aspect 16: A non-transitory computer-readable medium storing code for wireless communications at a UE, the code comprising instructions executable by at least one processor to perform a method of any of aspects 1 through 12.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein. Components within a wireless communication system may be coupled (for example, operatively, communicatively, functionally, electronically, and/or electrically) to each other.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information or signaling, e.g., receiving information or signaling for determining, receiving information or signaling for identifying), accessing (such as accessing data in a memory, or accessing information) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
at least one processor; and
memory coupled to the at least one processor, the memory storing instructions executable by the at least one processor to cause the UE to:
receive first control information that identifies a packet delay budget for wireless communications over a logical channel;
receive second control information that enables delay status reporting for protocol data units associated with the logical channel in accordance with a trigger; and
transmit a delay status report indicating a residual delay budget associated with a protocol data unit associated with the logical channel based at least in part on the trigger being satisfied, wherein the residual delay budget is a portion of the packet delay budget for the logical channel.

2. The apparatus of claim 1, wherein the instructions are further executable by the at least one processor to cause the apparatus to:
receive, with the second control information, a residual delay budget threshold for the logical channel, wherein the trigger is satisfied based at least in part on the residual delay budget satisfying the residual delay budget threshold.

3. The apparatus of claim 2, wherein the residual delay budget indicated in the delay status report is of a medium access control sub-protocol data unit, a radio link control sub-protocol data unit, or a packet data convergence protocol sub-protocol data unit associated with the logical channel.

4. The apparatus of claim 2, wherein:
the residual delay budget indicated in the delay status report is a smallest residual delay budget of a plurality of buffered protocol data units in the logical channel, and
the logical channel has a highest priority among a plurality of logical channels for which delay status reporting is enabled and which have non-empty buffers.

5. The apparatus of claim 1, wherein the instructions to transmit the delay status report are executable by the at least one processor to cause the apparatus to:
transmit the delay status report periodically, wherein the trigger is satisfied based at least in part on a periodicity parameter of the delay status report.

6. The apparatus of claim 1, wherein the instructions to transmit the delay status report are executable by the at least one processor to cause the apparatus to:
transmit the delay status report in portions of a physical uplink shared channel allocated for padding of a physical uplink shared channel payload.

7. The apparatus of claim 1, wherein the instructions to transmit the delay status report are executable by the at least one processor to cause the apparatus to:
transmit the delay status report in connection with a buffer status report being triggered for the logical channel, wherein the trigger is satisfied based at least in part on the buffer status report being triggered.

8. The apparatus of claim 1, wherein the instructions to transmit the delay status report are executable by the at least one processor to cause the apparatus to:
transmit the delay status report via an available physical uplink shared channel resource in a medium access control (MAC) control element.

9. The apparatus of claim 1, wherein the instructions are further executable by the at least one processor to cause the apparatus to:
receive an indication of a physical uplink control channel resource for the delay status reporting for the logical channel.

10. The apparatus of claim 9, wherein the instructions to transmit the delay status report are executable by the at least one processor to cause the apparatus to:
transmit the delay status report via a codepoint value included in the physical uplink control channel resource, wherein the codepoint value is indicative of the residual delay budget.

11. The apparatus of claim 9, wherein the trigger is associated with transmitting the delay status report via the physical uplink control channel resource.

12. The apparatus of claim 9, wherein the instructions to transmit the delay status report are executable by the at least one processor to cause the apparatus to:
transmit the delay status report via the physical uplink control channel resource over a number of transmission instances in accordance with one of the first control information or the second control information.

13. The apparatus of claim 1, wherein the packet delay budget comprises at least one of a packet delay budget of a quality of service flow associated with the logical channel or a protocol data unit set delay budget of a quality of service flow associated with the logical channel.

14. A method for wireless communications at a user equipment (UE), comprising:
receiving first control information that identifies a packet delay budget for wireless communications over a logical channel;
receiving second control information that enables delay status reporting for protocol data units associated with the logical channel in accordance with a trigger; and
transmitting a delay status report indicating a residual delay budget associated with a protocol data unit associated with the logical channel based at least in part on the trigger being satisfied, wherein the residual delay budget is a portion of the packet delay budget for the logical channel.

15. The method of claim 14, further comprising:
receiving, with the second control information, a residual delay budget threshold for the logical channel, wherein the trigger is satisfied based at least in part on the residual delay budget satisfying the residual delay budget threshold.

16. The method of claim 15, wherein the residual delay budget indicated in the delay status report is of a medium access control sub-protocol data unit, a radio link control sub-protocol data unit, or a packet data convergence protocol sub-protocol data unit associated with the logical channel.

17. The method of claim 15, wherein:
the residual delay budget indicated in the delay status report is a smallest residual delay budget of a plurality of buffered protocol data units in the logical channel, and
the logical channel has a highest priority among a plurality of logical channels for which delay status reporting is enabled and which have non-empty buffers.

18. The method of claim 14, wherein transmitting the delay status report comprises:
transmitting the delay status report periodically, wherein the trigger is satisfied based at least in part on a periodicity parameter of the delay status report.

19. The method of claim 14, wherein transmitting the delay status report comprises:
transmitting the delay status report in portions of a physical uplink shared channel allocated for padding of a physical uplink shared channel payload.

20. The method of claim 14, wherein transmitting the delay status report comprises:
transmitting the delay status report in connection with a buffer status report being triggered for the logical channel, wherein the trigger is satisfied based at least in part on the buffer status report being triggered.

21. The method of claim 14, wherein transmitting the delay status report comprises:
transmitting the delay status report via an available physical uplink shared channel resource in a medium access control (MAC) control element.

22. The method of claim 14, further comprising:
receiving an indication of a physical uplink control channel resource for the delay status reporting for the logical channel.

23. The method of claim 22, wherein transmitting the delay status report comprises:
transmitting the delay status report via a codepoint value included in the physical uplink control channel resource, wherein the codepoint value is indicative of the residual delay budget.

24. The method of claim 22, wherein the trigger is associated with transmitting the delay status report via the physical uplink control channel resource.

25. The method of claim 22, wherein transmitting the delay status report comprises:
transmitting the delay status report via the physical uplink control channel resource over a number of transmission instances in accordance with one of the first control information or the second control information.

26. An apparatus for wireless communications at a user equipment (UE), comprising:
means for receiving first control information that identifies a packet delay budget for wireless communications over a logical channel;
means for receiving second control information that enables delay status reporting for protocol data units associated with the logical channel in accordance with a trigger; and
means for transmitting a delay status report indicating a residual delay budget associated with a protocol data unit associated with the logical channel based at least in part on the trigger being satisfied, wherein the residual delay budget is a portion of the packet delay budget for the logical channel.

27. The apparatus of claim 26, further comprising:
means for receiving, with the second control information, a residual delay budget threshold for the logical channel, wherein the trigger is satisfied based at least in part on the residual delay budget satisfying the residual delay budget threshold.

28. The apparatus of claim 27, wherein the residual delay budget indicated in the delay status report is of a medium access control sub-protocol data unit, a radio link control sub-protocol data unit, or a packet data convergence protocol sub-protocol data unit associated with the logical channel.

29. The apparatus of claim 27, wherein:
the residual delay budget indicated in the delay status report is a smallest residual delay budget of a plurality of buffered protocol data units in the logical channel, and
the logical channel has a highest priority among a plurality of logical channels for which delay status reporting is enabled and which have non-empty buffers.

30. A non-transitory computer-readable medium storing code for wireless communications at a user equipment (UE), the code comprising instructions executable by at least one processor to:
receive first control information that identifies a packet delay budget for wireless communications over a logical channel;
receive second control information that enables delay status reporting for protocol data units associated with the logical channel in accordance with a trigger; and
transmit a delay status report indicating a residual delay budget associated with a protocol data unit associated with the logical channel based at least in part on the trigger being satisfied, wherein the residual delay budget is a portion of the packet delay budget for the logical channel.
